(19) United States
(12) Patent Application Publication
(10) Pub. No.: US 2016/0356029 A1
(43) Pub. Date: Dec. 8, 2016

(54) Hair and Waste Catching System

(71) Applicants: Lauren Marie Davis, Inverness, IL (US); Mauricio Gomes de Sá Ribeiro, Manaus (BR)

(72) Inventors: Lauren Marie Davis, Inverness, IL (US); Mauricio Gomes de Sá Ribeiro, Manaus (BR)

(21) Appl. No.: 14/730,450

(22) Filed: Jun. 4, 2015

(51) Int. Cl. E03C 1/264; B01D 35/28; B01D 35/02

(52) U.S. Cl. CPC E03C 1/264; B01D 35/02; B01D 35/28

(57) ABSTRACT

A hair and waste particle catching system comprises a housing and filter. The filter is separable from the housing. The system hides waste as it is collected, and allows the user to dispose of the waste without touching it. The filter prevents hair and waste particles from entering a drain. The housing holds the filter in place at the base of the drain and hides waste as it accumulates. The geometry of the housing enables fluids to flow rapidly into the drain opening so as not to cause stagnation in the tub or basin when the system is installed

### RELATED APPLICATIONS

The present application claims priority to U.S. Provisional Patent Application Ser. No. 62/007,443 which was filed on Jun. 4, 2014. The application is entirely incorporated by reference herein.

### BACKGROUND

This disclosure is directed toward a debris catching system that is used to prevent hair and other waste particles from entering a bath, shower, or sink drain. The system hides the waste as it is collected, and allows the user to dispose of the waste without touching it.

### BRIEF SUMMARY

This disclosure incorporates a filter and a housing for prevention of hair and waste particles from entering the bath, shower, sink plumbing, or the like. The filter component and housing component are separate parts to a system. The filter fits inside of the housing when the system is assembled. The filter component prevents hair and other waste particles from entering a drain. The housing keeps the filter in place at the base of the drain and hides waste as it accumulates in the filter. The geometry of the housing enables fluids to flow more rapidly into the drain opening so as not to cause stagnation in the tub or basin when the system is installed. In the preferred embodiment, the housing is made from opaque silicone rubber and has a metal support ring embedded in the top opening. When the system is in use, a filter must be attached within the housing and the housing pressed tightly to the tub surface. The preferred embodiment of the filter is a recyclable plastic hollow cone with a plurality of perforations on the curved face of the cone. The base of the cone is wider than the top of the cone and is configured to be a flat ring with a plurality of pointed protrusions configured to grasp hair and other debris. During use, the flat ring at the base sits tightly against the face of the drain, basin, or other surface. Within the hollow filter are protruding tabs that can be used to discard the filter without having to touch the waste. If the user does not wish to dispose of the filter, it can easily be cleaned by hand for reuse.

### BRIEF DESCRIPTION OF THE DRAWINGS

FIG. 1 illustrates an axonometric view of the disassembled system from above showing the housing and filter as individual components.

FIG. 2 illustrates an axonometric view of the system fully assembled.

FIG. 3 illustrates a view of the top face of the housing showing hollow geometry, which allows for any drain stopper to function and be accessed while the system is in place.

FIG. 4 illustrates a view of the bottom face of the housing showing location of filter attachment and canal walls, which direct the flow of water.

FIG. 5 illustrates a section through the assembled system.

FIG. 6 illustrates a section through the disassembled system.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made without departing from the scope and spirit of the present disclosure. Those skilled in the art with the benefit of this disclosure will appreciate that practice disclosure is not limited to the illustrative embodiments herein.

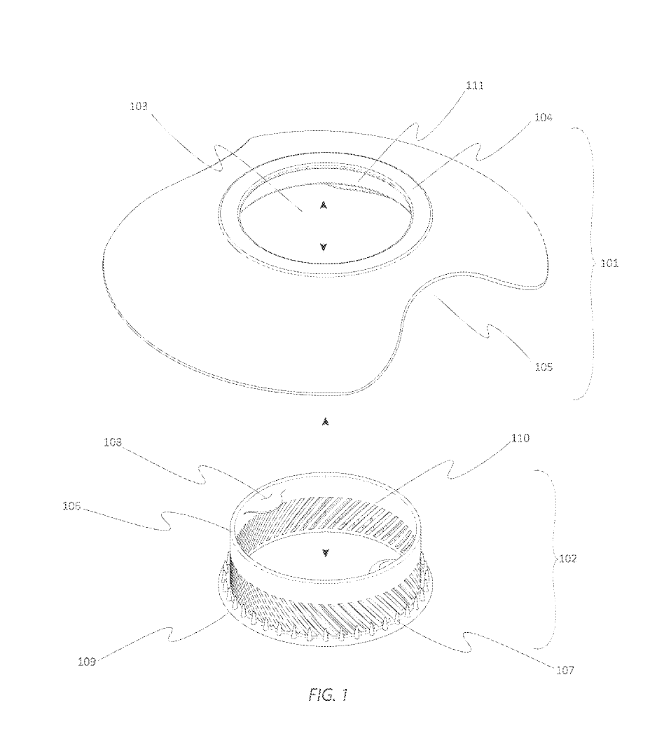

The preferred embodiment of this disclosure is shown in FIGS. 1-6. As shown in FIG. 1, the hair catcher comprises a housing 101 and a filter 102. In one embodiment, the housing 101 is made from flexible material so that its bottom edge conforms to the surface of any basin. In other embodiments the housing 101 may be made of rigid material or a combination of flexible and rigid materials. For instance, elastomeric compounds that may be used to construct the housing include Styrene-Butadiene Elastomers (SBC, SBS, SBR). The rigid material may be hard plastic such as Acrylonitrile-butadiene-styrene (ABS) or Polypropylene (PP). The housing may also be made of ceramic compounds or glass. In a further embodiment, the housing and filter comprise a single piece.

The domed (convex) geometry of the housing 101 hides any hair or waste particles while the system is in use. The geometry of the housing may be any shape as long as it is convex to (bulges out from) the basin surface. The top of the housing may be at least large enough to hide the waste and/or debris that accumulates around the filter. The bottom edges of the housing may be in contact with the surface of the basin and may be wider than the drain body. The overall dimensions of the housing may be 5″ wide and 4″ deep. In another embodiment the overall dimensions of the housing may be greater than 5″ wide and less than 4″ deep. In other embodiments the overall dimensions of the housing may be less than 5″ wide and greater than 4″ deep. In another embodiment the width and depth of the housing may be equal in dimension. In further embodiments the overall width of the housing is adapted based upon the overall housing and filter geometry. The top of the housing may be at least 1″ above the basin surface. The housing may be shaped as different characters or objects as well, such as animals or plants to coordinate with other home decor.

The opening 103 through the top of the housing allows any existing bathtub drain and drain stopper to function and be accessed while the system is in place. For this reason, the system can be used with any kind of bathtub or basin drain, including those with a twist-and-pull or pop-up stopper. The opening 103 may be embodied in a variety of geometries.

The top inside surface of the housing 111 holds the filter within the housing 101. The top inside surface of the housing 111 may be cylindrical in nature with a diameter equal to or less than the outer diameter of the top of the filter component 106. The top inside surface of the housing 111 may be embodied in a variety of geometries such that the geometry of the filter 102 fits snugly within the inside surface of the housing. In other embodiments the top inside surface of the housing may be greater than the diameter of the top of the filter component 106. In further embodiments the top inside surface of the housing is adapted based upon the overall housing and filter geometry.

Curved openings 105 in the sides of the housing 101 allow for water to pass through the housing and into the drain. In other embodiments the curved openings may be sinusoidal shaped. In further embodiments, the openings are 3″ wide by ¾″ high. In other embodiments, the sinusoidal shaped openings may be greater than 1″ but less than 3″ wide. In further embodiments, the openings may be greater than 3″ wide. In other embodiments the openings may be greater than ⅛″ high but less than ¾″ high. In further embodiments the openings may be greater than ¾″ high. In further embodiments the openings are adapted based upon the overall housing geometry and the size of the drain opening.

A support ring 104 attached to or embedded (enclosed) within the top of the housing helps to maintain the structure of a flexible housing. The support ring 104 may be made of stainless steel, aluminum, or a rigid plastic compound such as Acrylonitrile-butadiene-styrene (ABS) plastic. The support ring may be embedded into the top of the housing by a double-injection molding process. In other embodiments, the ring is partially embedded with a portion of the ring exposed at the top. In addition, the support ring 104 helps to hold the filter 102 in place when the system is assembled by providing pressure for the filter to tension fit into the housing.

The filter 102 has hollow geometry. The filter has 60 equally spaced, diagonal perforations 110, which allow fluid to pass through while catching hair and other waste particles. In other embodiments, the filter may have less or more than 60 perforations. Each perforation is 2 mm wide and 15 mm tall and diagonal at a 45-degree angle. The number and shape of the perforations may be different as long as fluid is permitted to pass through and debris is unable to pass through. In one embodiment of the filter 102, 40 pointed protrusions 107 are extruded from the base 109. The protrusions may protrude vertically, horizontally, or at an angle.

In the one embodiment, the filter 102 may be made from a low-cost, rigid material. In alternate embodiments the filter 102 may be made of flexible material, or a combination of flexible and rigid materials. For instance, the base of the filter 109 may include an additional flexible bottom layer of elastomeric material such as silicone rubber to create an additional seal with a surface.

The filter 102 may be ejected from the housing 101 using a variety of methods. In the one embodiment, the filter 102 may be ejected manually by the pushing of inwardly protruding tabs, which are part of the top portion of the filter 108. In an alternative embodiment the filter 102 may be ejected manually without tabs or via a mechanical mechanism actuated by the push of a button, which may be connected to the housing and made of the same or similar material as the housing. The buttons may be soft or rigid.

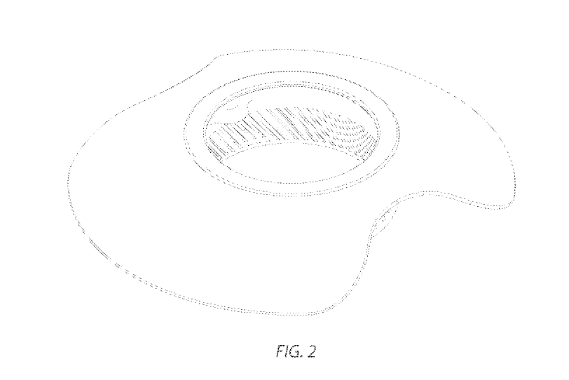

FIG. 2 illustrates the fully assembled system.

FIG. 3 illustrates a view of the top face of the housing showing an opening 303. The opening 303 allows for any drain stopper to function and be accessed while the system is in place. Additionally, FIG. 3 illustrates a plurality of side openings 305. The top opening 303 in the housing and the side openings 305 may be embodied in a variety of geometries.

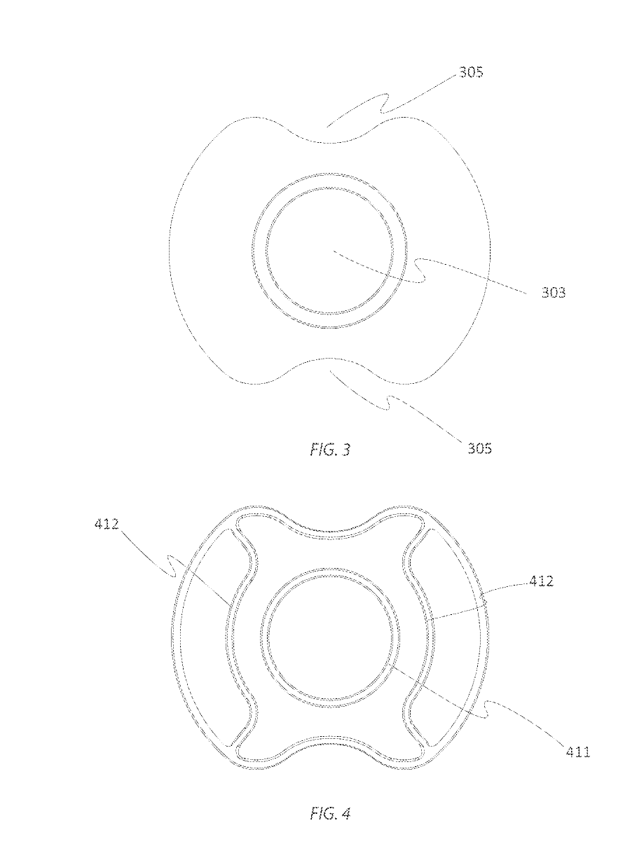

FIG. 4 illustrates a view of the bottom face of the housing showing the location of filter attachment to the housing 411 and a plurality of canal walls 412, which direct the flow of water through the housing 101. In one embodiment the canal walls 412 are part of the molded housing component. As such, they are made of the same material as the housing. In another embodiment they may be a separate part that is connected to the housing. In that case, they may be different material than the housing. For instance, if the housing was made from a ceramic compound, then the canal walls may be made of a silicone rubber compound.

The location of filter attachment of the housing may vary. Canal walls 412 in one embodiment are curved in a sinusoidal manner. In other embodiments the canal walls 412 may be embodied in a variety of curved geometries under the condition that they have a diameter at least ½″ greater than the outer edge of the drain base and sit tightly against the fluid basin.

FIG. 5 illustrates a section view through the housing 501, the filter 502, a standard drain base 503 and standard basin surface 504 as an assembled system.

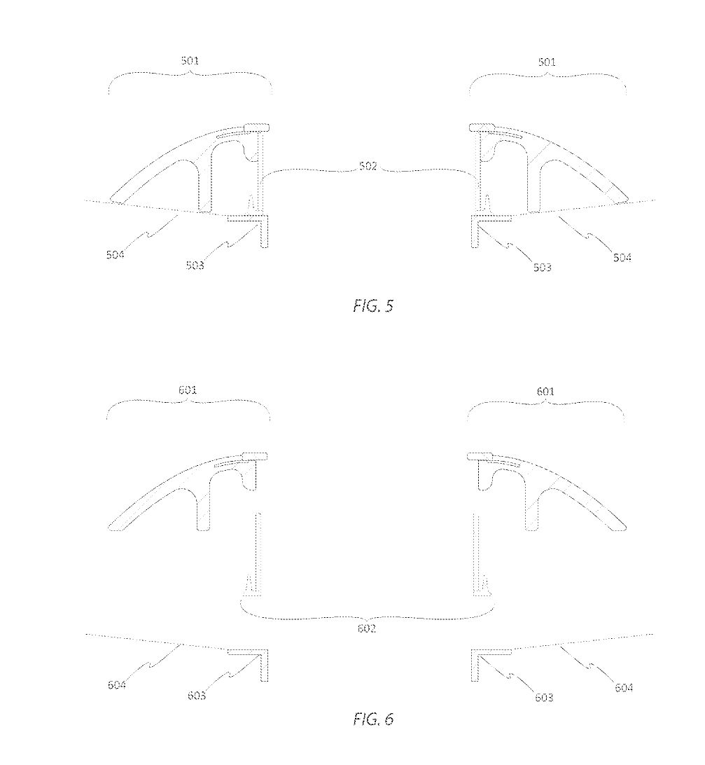

FIG. 6 illustrates a section view through the housing 601, the filter 602, a standard drain base 603 and standard basin surface 604 as a disassembled system.

Many other embodiments of this disclosure are possible. For instance, the filter component 102 or housing 101 may include a compartment containing a scented component or substance similar to bath oil or an air freshener. Additionally, the filter 102 or housing 101 may include a medicinal component released as vapor. Another embodiment of the filter 102 or housing 101 may include a chemical component that dissolves hair and waste as it enters the filter. The housing 101 or filter 102 may also include mechanical components, which may fragment hair and waste so it can pass through a plumbing system more easily.

Another embodiment of the disclosure may include a stopper-like component. The system may also include lighting or sound components. In another variation, the opening in the top of the housing 3 may be omitted. Additionally, the filter 102 and housing 101 may be scaled to fit a variety of sizes and shapes for geometrically irregular drains and basins. For example, the system may be adapted to fit linear drains. The system may also be adapted to attach to drains mounted at a variety of angles.

### CONCLUSION

This disclosure is directed toward a hair and waste catching system that is adaptable to various different drains and capable of use with existing drain stoppers, with enhanced water flow, disposable filters and is easy to clean.

Aspects of the embodiments have been described in terms of illustrative embodiments thereof. Numerous other embodiments, modifications and variations within the scope and spirit of the appended claims will occur to persons of ordinary skill in the art from a review of this disclosure.

What is claimed is:

1. A system comprising:
a. a dome shaped housing, the housing further comprises a ring, a canal wall, and an opening; and
b. a hollow filter, the filter further comprises a plurality of perforations, a plurality of protrusions, and a tab.

2. The system in claim 1, wherein the housing is made from flexible material.

3. The system in claim 1, wherein the housing is made from rigid material.

4. The system in claim 1, wherein the housing is made from a combination of flexible material and rigid material.

5. The system in claim 1, wherein the housing is made from ceramic compounds or glass.

6. The system in claim 1, wherein the housing is made of opaque silicone rubber.

7. The system in claim 1, wherein the housing further comprises an opening at the top.

8. The system in claim 1, wherein the housing is configured to be large enough to hide the waste and debris that accumulates around the filter.

9. The system in claim 1, wherein the ring is fully embedded in a top opening of the housing.

10. The system in claim 1, wherein the ring is partially embedded in a top opening of the housing.

11. The system in claim 1, wherein the opening is sinusoidal shaped.

12. The system in claim 1, wherein the housing comprises two or more canal walls.

13. The system in claim 1, wherein the canal wall is configured to increase water flow into the drain opening.

14. The system in claim 1, wherein the canal wall is sinusoidal shaped.

15. The system in claim 1, wherein the filter is cone shaped.

16. The system in claim 1, wherein the filter further comprises a flat ring at the base.

17. The system in claim 1, wherein the plurality of perforations are equally spaced and diagonal.

18. The system in claim 1, wherein the filter base further comprises an elastomeric material.
